(19) United States
(12) Patent Application Publication
(10) Pub. No.: US 2024/0405340 A1
(43) Pub. Date: Dec. 5, 2024

(54) BATTERY PACK AND CORRESPONDING VEHICLE

(71) Applicant: Ford Global Technologies, LLC, Dearborn, MI (US)

(72) Inventors: Fei Gao, Hefei (CN); Larry Wang, Nanjing (CN); Robin Zhou, Nanjing (CN)

(21) Appl. No.: 18/677,333

(22) Filed: May 29, 2024

(30) Foreign Application Priority Data
Jun. 2, 2023 (CN) 2023106470033

(51) Int. Cl. H01M 50/262; B60L 50/60; B60R 16/033; H01M 10/613; H01M 10/625; H01M 10/656; H01M 50/209; H01M 50/242

(52) U.S. Cl. CPC H01M 50/262; B60R 16/033; H01M 10/613; H01M 10/625; H01M 10/656; H01M 50/209; H01M 50/242; B60L 50/60; H01M 2220/20

(57) ABSTRACT

The present disclosure provides a battery pack and corresponding vehicle. The battery pack comprises: a tray; a mid-tray; a first battery array arranged in the mid-tray; a second battery array arranged in the tray; a first beam extending in a first direction and arranged in the tray; and array brackets extending in a second direction different from the first direction, wherein opposite ends of the first battery array in the first direction are connected to the tray through the array brackets.

### CROSS-REFERENCE TO RELATED APPLICATIONS

This disclosure claims priority to Chinese Patent Application No. 2023106470033, which was filed on 2 Jun. 2023 and is incorporated herein by reference in its entirety.

### TECHNICAL FIELD

The present disclosure generally relates to the field of batteries, and more specifically, to a battery pack and corresponding vehicle.

### BACKGROUND

With the development of modern motor vehicles, the demand for driving range has increased and the number of various electrical devices inside the vehicle has increased. These situations will lead to an increase in the demand for vehicle electricity; resulting in a larger space occupied by battery packs used to provide power to the vehicle and a more complex internal structure. At present, in order to achieve higher space utilization efficiency, battery pack design schemes with multi-layer structure have been proposed in existing technologies.

For example, U.S. patent application Ser. No. 16/749,107 provides a traction battery pack with second tier integrated supporting, thermal, and sealing structures. The battery pack may include an enclosure assembly and a plurality of battery arrays housed inside the enclosure assembly. The enclosure assembly may include a mid-tray configured to support, cool/heat, and seal second tier battery arrays.

### SUMMARY

The present disclosure summarizes aspects of the embodiments and should not be used to limit the claims. Other implementations are contemplated in accordance with the techniques described herein, as will be apparent to those skilled in the art upon examination of the following drawings and detailed description, and such implementations are intended to be within the scope of this application.

According to an aspect of the present disclosure, a battery pack is provided, comprising:
a tray;
a mid-tray;
a first battery array arranged in the mid-tray;
a second battery array arranged in the tray;
a first beam extending in a first direction and arranged in the tray; and
array brackets extending in a second direction different from the first direction,
wherein opposite ends of the first battery array in the first direction are connected to the tray through the array brackets.

According to an embodiment of the present disclosure, the array brackets are supported at ends of the second battery array in the first direction and supported on the tray through the second battery array.

According to an embodiment of the present disclosure, an angle between 80 and 100 degrees is formed between the first direction and the second direction.

According to an embodiment of the present disclosure, the mid-tray is supported on and fixed to the array brackets.

According to an embodiment of the present disclosure, the mid-tray comprises tray lugs at its edges, the array bracket comprises longitudinally extended support legs and a transverse arm portion connected to the support legs, wherein the tray lugs are supported on and fixed to the transverse arm portions of the array brackets.

According to an embodiment of the present disclosure, the array bracket comprises at least an H-shaped structure.

According to an embodiment of the present disclosure, the battery pack further comprises mid-tray brackets extending along the first direction, through which the mid-tray is supported on the tray.

According to an embodiment of the present disclosure, the first battery array comprises several first battery cells arranged side by side along the first direction and first endplates that compresses the first battery cells in the first direction from both sides, the second battery array comprises several second battery cells arranged side by side along the first direction and second endplates that compresses the second battery cells in the first direction from both sides, the array brackets are connected to the first endplates and the second endplates, and the second endplates are supported on the tray.

According to an embodiment of the present disclosure, the array brackets form a part of the first endplates and/or the second endplates.

According to an embodiment of the present disclosure, the mid-tray comprises a first cooling circuit for thermal management of the first battery array.

According to an embodiment of the present disclosure, the mid-tray comprises a first plate, a second plate, and a third plate, the first plate is connected to the second plate and the first cooling circuit is formed between the two, the first plate is in contact with the first battery array, and the third plate is connected to the second plate.

According to an embodiment of the present disclosure, the first battery array comprises several first battery cells arranged side by side along the first direction, insulation films are arranged between the first battery cells and insulation film is not included on the side facing the first plate, and several insulation separators are arranged between the first plate and the first battery cells to separate the first plate from the side facing the first plate of the first battery cells.

According to an embodiment of the present disclosure, the battery pack further comprises a third battery array arranged in the mid-tray and spaced apart from the first battery array, the first cooling circuit comprises a first sub circuit for thermal management of the first battery array and a second sub circuit for thermal management of the third battery array, and the first sub circuit and the second sub circuit are connected in parallel.

According to an embodiment of the present disclosure, the mid-tray comprises a mid-tray flange extending upwards around its periphery.

According to an embodiment of the present disclosure, the first endplate comprises a first portion that protrudes from a vertical middle position at an installation position and a second portion that extends from the first portion to upper and lower sides, and the second endplate comprises a third portion that protrudes from a vertical middle direction at the installation position and a fourth portion that extends from the third portion to upper and lower sides.

According to an embodiment of the present disclosure, the battery pack further comprises support connectors, the first portion, the third portion, and the array bracket each contain several vertically extended through holes, and the support connectors sequentially pass through the through holes in the first portion, the array bracket, and the third portion and are further fixed to the tray.

According to an embodiment of the present disclosure, the tray comprises a tray frame extending along the second direction, and the support connectors are fixed to the tray frame.

According to an embodiment of the present disclosure, the mid-tray is connected to the first beam.

According to an aspect of the present disclosure, a battery pack is provided, comprising:
a tray;
a mid-tray;
a first battery array arranged in the mid-tray and extending in a first direction; and
a second battery array arranged in the tray;
wherein opposite ends of the first battery array in the first direction are connected to the tray.

According to an aspect of the present disclosure, a vehicle comprising the battery pack as described in any of the above embodiments.

Further refinements are disclosed in the subclaims and in the following description of the figures.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

For a better understanding of the present disclosure, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further in the figures, like reference numbers refer to like parts throughout the different figures.

FIG. 1 shows a schematic diagram of a vehicle comprising a battery pack according to one or more embodiments of the present disclosure;

FIG. 2 shows a perspective view of the battery pack according to one or more embodiments of the present disclosure;

FIG. 3 shows a perspective view of the battery pack according to one or more embodiments of the present disclosure, with the cover removed;

FIG. 4 shows a partial exploded view of the battery pack according to one or more embodiments of the present disclosure;

FIG. 5 shows a partial view of the battery pack according to one or more embodiments of the present disclosure;

FIG. 6 shows a partial view of the battery pack according to one or more embodiments of the present disclosure, with the first battery cells removed;

FIG. 7 shows a partial view of the battery pack according to one or more embodiments of the present disclosure, with the first battery cells and a portion of the tray frame removed;

FIG. 8 shows a partial sectional view of the battery pack according to one or more embodiments of the present disclosure along a second direction;

FIG. 9 shows a partial view of the battery pack according to one or more embodiments of the present disclosure, with the first battery cells, second battery cells, and a portion of the tray frame removed;

FIG. 10 shows a partial sectional view of the battery pack according to one or more embodiments of the present disclosure along a first direction;

FIG. 11 shows a perspective view of a first endplate of the battery pack according to one or more embodiments of the present disclosure;

FIG. 12 shows a perspective view of an array bracket of the battery pack according to one or more embodiments of the present disclosure;

FIG. 13 shows a perspective view of a second endplate of the battery pack according to one or more embodiments of the present disclosure;

FIG. 14 shows a perspective view of a mid-tray of the battery pack according to one or more embodiments of the present disclosure;

FIG. 15 shows a partial sectional view of the mid-tray of the battery pack according to one or more embodiments of the present disclosure;

FIG. 16 shows a schematic diagram of the distribution of a first cooling circuit of the mid-tray of the battery pack according to one or more embodiments of the present disclosure;

FIG. 17 shows a perspective view of a tray of the battery pack according to one or more embodiments of the present disclosure;

FIG. 18 shows an end perspective view of a battery pack according to another one or more embodiments of the present disclosure, with a portion of the tray frame removed; and

FIG. 19 shows an end perspective view of a battery pack according to yet another one or more embodiments of the present disclosure, with a portion of the tray frame removed.

### DETAILED DESCRIPTION

Embodiments of the present disclosure are described below. However, it is to be understood that the disclosed embodiments are merely examples and other embodiments may take various and alternative forms. The figures are not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure. As will be understood by those of ordinary skill in the art, various features shown and described with reference to any one figure may be combined with features shown in one or more other figures to produce embodiments not expressly shown or described. The combinations of features shown herein provide representative embodiments for typical disclosures. However, various combinations and modifications of the features consistent with the teachings of the present disclosure may be desired for certain particular applications or implementations.

In this application document, when an element or part is referred to as being “on . . . ”, “bonded to”, “connected to”, or “coupled to” another element or part, the element or part can be directly on another element or part, can be bonded, connected or coupled to another element or part, or there may be intervening elements or parts. In contrast, when an element is referred to as being “directly on . . . ”, “directly bonded to”, “directly connected to”, or “directly coupled to” another element or part, the intervening elements or parts may not be present. Other words used to describe the relationship between elements should be interpreted in a like fashion.

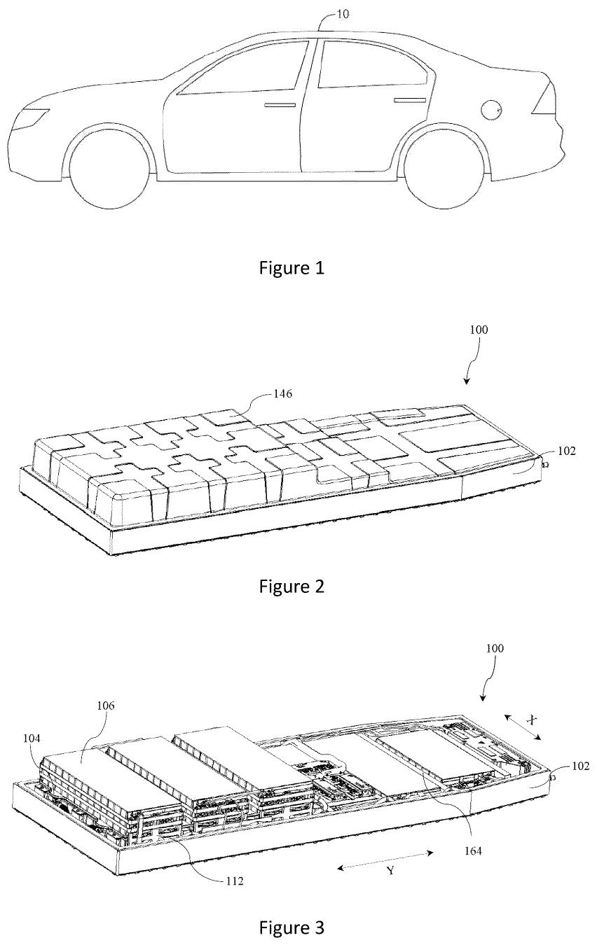

FIG. 1 provides a schematic diagram of a vehicle 10 including a battery pack 100 according to one or more embodiments of the present disclosure. It should be understood that in the context of the present disclosure, the vehicle 10 implementing the present disclosure can refer to any means of transportation including a vehicle battery pack, such as but not limited to, fossil fuel vehicles, electric vehicles (such as plug-in hybrid electric vehicles (PHEVs), fully hybrid electric vehicles (FHEVs), mild hybrid electric vehicles (MHEVs) or battery electric vehicles (BEVs), and even ships, aircrafts, etc. The vehicle 10 can include components related to mobility, such as engine, electric motor, transmission, suspension, drive shaft, and/or wheels. The vehicle 10 can be non-autonomous, semi-autonomous (for example, some conventional motion functions are controlled independently by the vehicle) or autonomous (for example, motion functions are controlled independently by the vehicle without direct input from user).

An exemplary aspect of the present disclosure provides a battery pack 100. Overall, as shown in FIGS. 2 to 18, the battery pack 100 comprises a tray 102, a mid-tray 104, a first battery array 106, a second battery array 108, a first beam 164, and array brackets 112. The first battery array 106 is arranged in the mid-tray 104, and the second battery array 108 and the first beam 164 are arranged in the tray 102. The first beam 164 extends along a first direction X, and the array brackets 112 extend along a second direction Y that is different from the first direction X. Wherein, opposite ends 110 of the first battery array 106 in the first direction X are connected to the tray 102 through the array brackets 112.

In the context of the present disclosure, directional expressions such as “first direction X”, “second direction Y”, “vertical direction”, “upper”, “lower”, “front”, “rear”, “lateral”, “top”, and “bottom” mentioned above and in the following disclosure relate to the battery pack in its installed state and the vehicle it is installed in. For example, “first direction X” can generally correspond to the left and right directions of the vehicle 10 to which the battery pack 100 is installed, that is, the lateral direction of the vehicle; “second direction Y” can generally correspond to the front and rear directions of the vehicle 10, and so on. Furthermore, “opposite ends 110 of the first battery array 106 in the first direction X” should be understood as simultaneously covering the positions near the both ends of the first battery array 106 in the first direction X, and being not limited to its end face. Furthermore, in one or more embodiments, the opposite ends 110 are “connected” to the tray 102, which should be understood as at least 20% or more of the weight of the first battery array 106 being supported by the tray 102 through this connection, i.e. being transmitted to the tray, in other words, the opposite ends 110 is “supported” on the tray 102. In addition, referring to FIGS. 2, 3, and 4, it can be seen that the first battery array 106 and the second battery array 108 are generally arranged in a double-layer structure, the battery array located in an upper layer can only cover a part of the battery array located in a lower layer, that is, they form a partially double-layer structure; in other examples, the battery array located in the upper layer can cover all the battery arrays located in the lower layer, that is, they form a complete double-layer structure.

In the embodiments of the present disclosure, it can be provided that the first beam 164 extends along the first direction X and the array brackets 112 extend along the second direction Y that is different from the first direction X, and the opposite ends 110 of the first battery array 106 located in the upper layer in the first direction X are connected to the tray 102 through the array brackets 112. The above structural features can firstly eliminate the need for beams to be installed in the mid-tray 104, simplify the battery pack structure, reduce weight, and increase battery space to a certain extent; and can secondly provide a more stable support for the first battery array 106 and can maintain or enhance the structural strength of the battery pack by extending the array brackets 112 in a direction different from the first beam 164, thereby not compromising or even improving the overall structural strength of the battery pack to some extent.

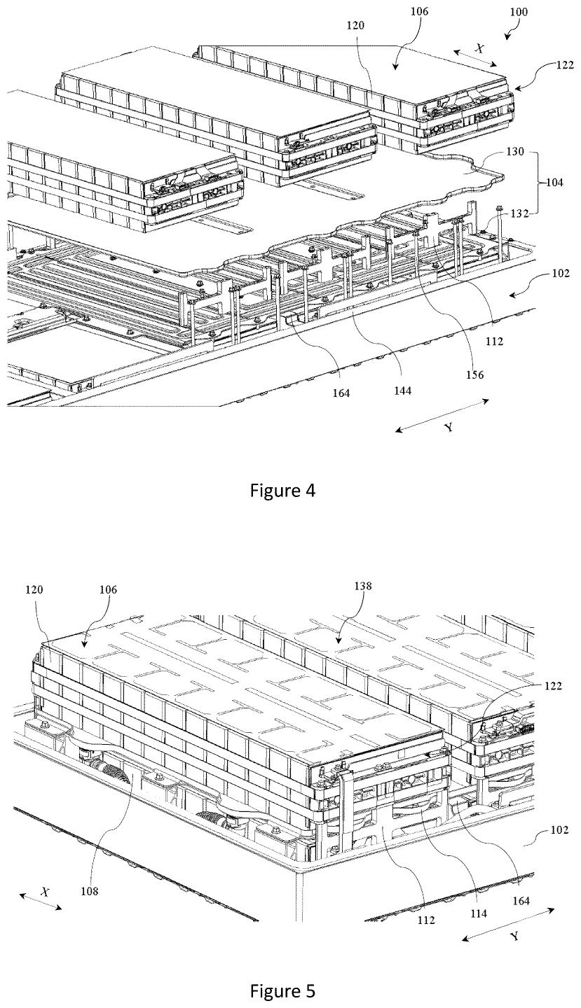

Referring to the perspective view shown in FIG. 2, the battery pack 100 may also include a cover 146. The tray 102 may further include a tray flange 144, as shown in FIG. 4. The cover 146 is connected to the tray flange 144 in a sealed manner, for example, by bonding, fastening, or combining the two, to form a chamber that generally accommodates the battery cells between the cover 146 and the tray 102.

As shown in FIG. 3, in several embodiments according to the present disclosure, an angle between 80 degrees and 100 degrees can be formed between the first direction X and the second direction Y; in further embodiments, the angle between the first direction X and the second direction Y can be between 85 degrees and 95 degrees; in other embodiments, the angle can be 90 degrees, that is to say, the first direction X and the second direction Y are perpendicular to each other. Technicians in this field can understand that the angle can be adjusted within a certain range to adapt to different battery layouts, which is not outside the scope of protection intended by the present disclosure.

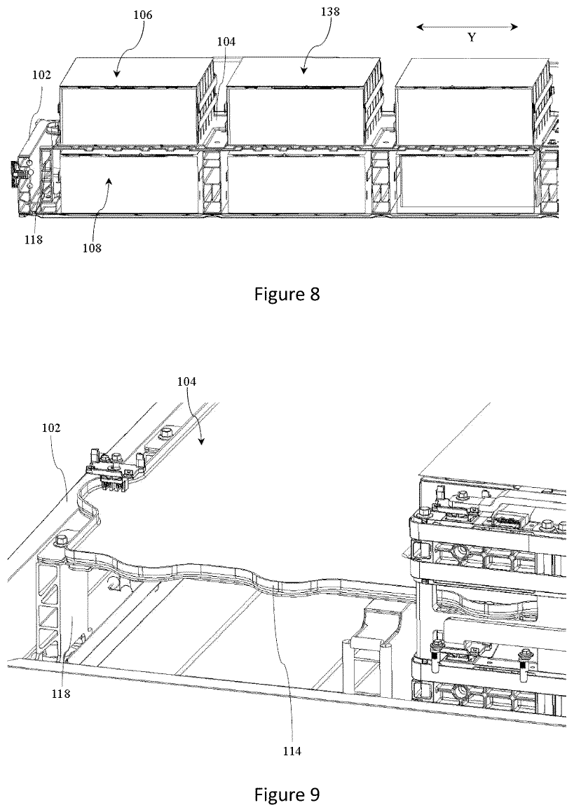

The second battery array 108 also has opposite ends 162 in the first direction X. As shown in FIG. 9, in some embodiments, the array brackets 112 are supported at the ends 162 and further supported on the tray 102 through the ends 162. That is to say, the ends 110 of the first battery array 106 are supported on the array brackets 112, the array brackets 112 are supported on the ends 162 of the second battery array 108, and finally supported on the tray 102 through the ends 162. Thus, an overall stable support structure is formed by the first battery array 106, the second battery array 108, the array brackets 112, and the tray 102, which enhances the structural strength of the battery pack.

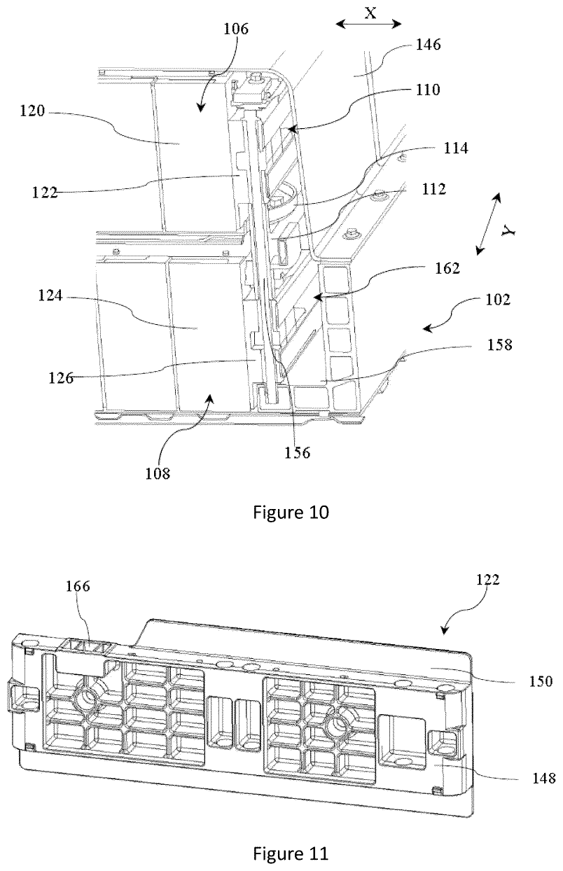

Referring to FIGS. 5 and 10 below, in some embodiments of the present disclosure, the first battery array 106 comprises several first battery cells 120 and first endplates 122, and the second battery array 108 comprises several second battery cells 124 and second endplates 126. The first battery cells 120 and the second battery cells 124 are arranged side by side along the first direction X. The first battery cells 120 are compressed from both sides in the first direction X by the first endplates 122, and the second battery cells 124 are compressed from both sides in the first direction X by the second endplates 126. The array brackets 112 are connected to the first endplates 122 and the second endplates 126, and the second endplates 126 are supported on the tray 102. That is to say, the first endplates 122 of the first battery array 106 are supported on the array brackets 112, the array brackets 112 are supported on the second endplates 126 of the second battery array 108, and finally supported on the tray 102 through the second endplates 126. This approach allows for the formation of stable overall support through a more simplified structure, improving the structural strength of the battery pack.

In FIG. 5, it can be seen that the size of the first battery cells 120 extending along the first direction X is smaller than its size extending along other directions, and the size of the second battery cells 124 extending along the first direction X is smaller than its size extending along other directions. That is to say, the first direction X corresponds to the extension direction of the shortest edge of the polyhedron formed by the first battery cells 120 and the second battery cells 124. However, it should be understood that the concept of the present disclosure is not limited to the arrangement of the battery cells shown in the figure, but can be extended to any possible battery cell layout, such as inclined arrangement at a certain angle or horizontal arrangement, etc. In some embodiments, the first battery cells 120 and the second battery cells 124 may be prismatic lithium-ion battery cells. However, within the scope of this disclosure, battery cells with other geometric shapes (such as cylindrical, bag-shaped, etc.), other chemicals (nickel metal hydride, lead acid, etc.), or both can be used as an alternative.

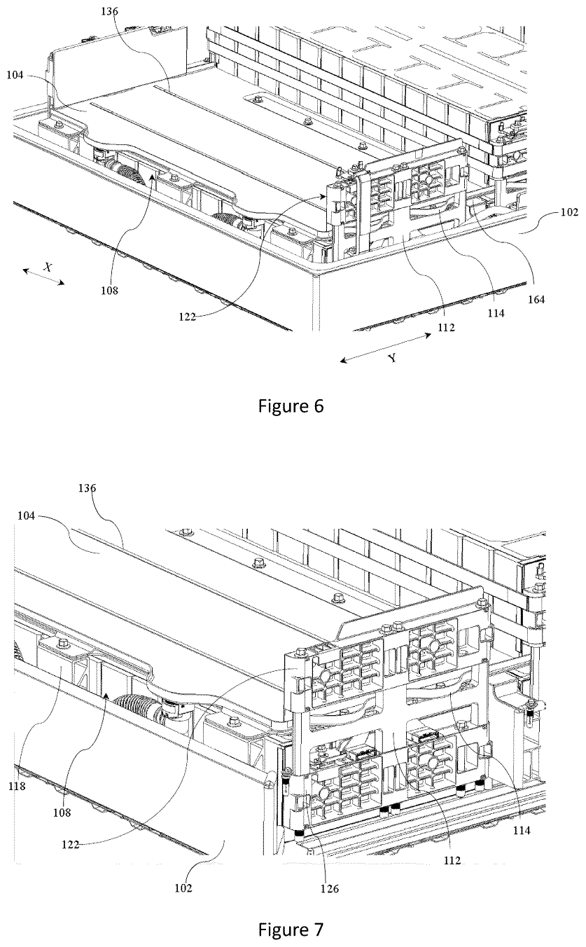

Referring to FIGS. 6 and 7, and also to FIGS. 11 and 13, in several embodiments of the present disclosure, the first endplate 122 comprises a first portion 148 and a second portion 150. The first portion 148 protrudes from a vertical middle position at an installation position, and the second portion 150 extends from the first portion 148 to upper and lower sides. The second endplate 126 includes a third portion 152 and a fourth portion 154. The third portion 152 protrudes from a vertical middle position at the installation position, and the fourth portion 154 extends from the third portion 152 to upper and lower sides. In this structure, the first portion 148 and the third portion 152 provide connection and support positions between the endplates, and the second portion 150 and the fourth portion 154 provide more comprehensive compression force coverage for the expansion tendency of the battery cells during the working cycle. At the same time, the structure also saves overall weight. In some embodiments, slots 166 and 168 for array wiring can also be arranged on the first portion 148 and the third portion 152.

Next, referring to FIG. 7 and further to FIGS. 4 and 10, according to some embodiments of the present disclosure, the battery pack 100 further includes support connectors 156. The first portion 148, the third portion 152, and the array bracket 112 can include several vertically extended through holes. The support connectors 156 sequentially pass through the through holes in the first portion 148, the array bracket 112, and the third portion 152 and are further fixed to the tray 102, as shown in the sectional view of FIG. 10. This feature can provide better connection stability and support, and manufacturing and assembly are relatively simple.

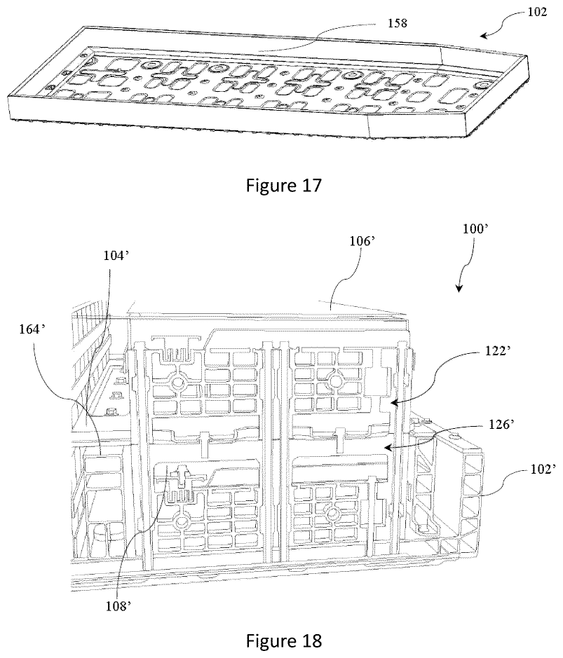

Referring to FIGS. 10 and 17, according to some embodiments of the present disclosure, the tray 102 may include a tray frame 158 extending in the second direction Y, and the support connectors 156 are fixed to the tray frame 158. The tray frame 158 can, for example, be a longitudinal part of the frame of the tray 102, to provide structural support for the tray 102. Fixing the support connectors 156 to the tray frame 158 can better distribute the weight of the supported first battery array 106 and other components.

Referring to FIGS. 5, 6, and 7, in some embodiments of the present disclosure, the mid-tray 104 may be supported on and fixed to the array brackets 112, for example, but not limited to, by means of fasteners, clamps, etc., to maintain the relative position of the mid-tray 104 and facilitate structural stability.

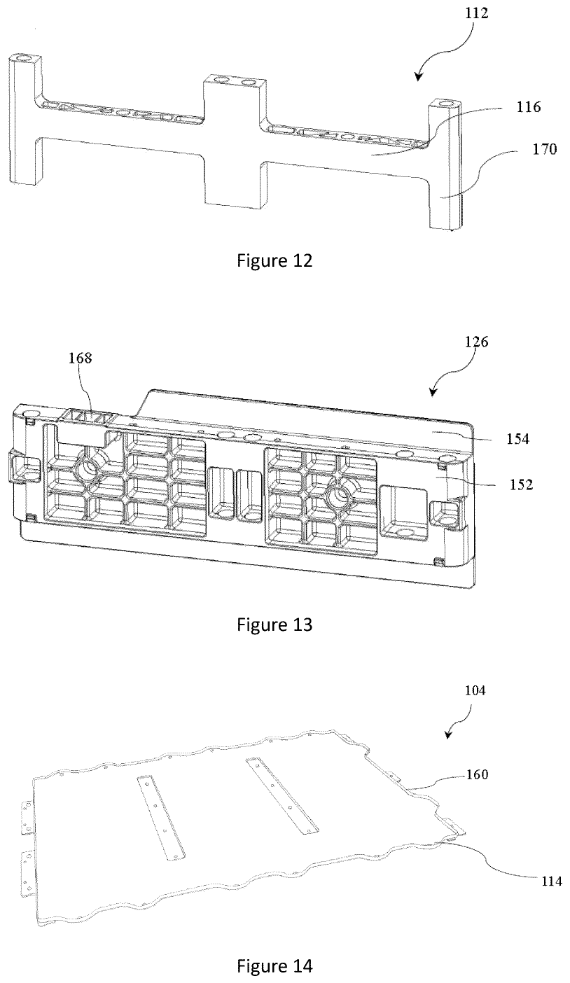

Further referring to FIGS. 5, 6, and 7, and also referring to FIG. 12, the mid-tray 104 includes tray lugs 114 at its edges, the array bracket 112 includes longitudinally extended support legs 170 and a transverse arm portion 116 connected to the support legs 170, wherein the tray lug 114 are supported on and fixed the transverse arm portion 116 of the array brackets 112. For example, the tray lugs 114 is supported on the transverse arm portion 116 and fixed there through fasteners, clamps, and other means. This feature further enhances the stability of the overall structure of the battery pack. In some further embodiments, the array bracket 112 comprises at least an H-shaped structure, or several H-shaped structures, such as a double H-shaped structure shown in FIG. 12, thereby further enhancing the support force of the array bracket 112.

As shown in FIGS. 14, 15, and 16, in some embodiments of the present disclosure, a first cooling circuit 128 may be disposed inside the mid-tray 104, coolant can be included inside the first cooling circuit 128 for thermal management of the first battery array 106. In this scheme, the integration of the cooling circuit inside the mid-tray simplifies the overall structure and saves space inside the battery pack in the vertical direction.

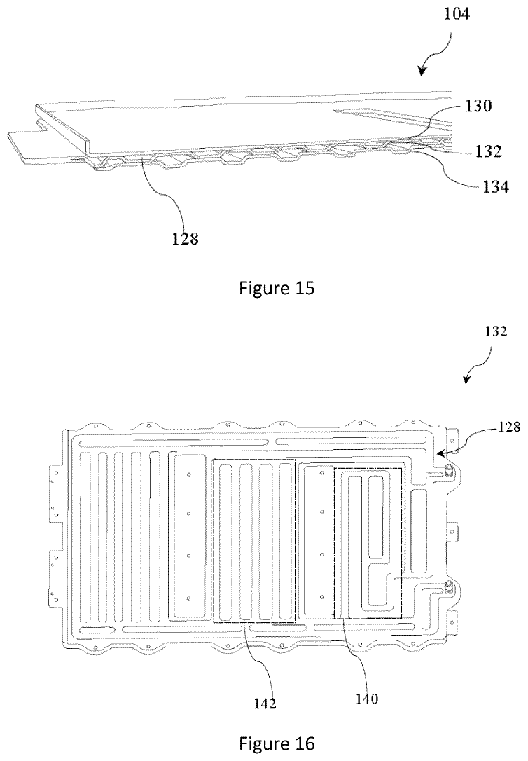

As shown in FIG. 15, in some embodiments of the present disclosure, the mid-tray 104 may include sequentially connected first plate 130, second plate 132, and third plate 134. The first plate 130 and the second plate 132 are connected to each other and the first cooling circuit 128 is formed between the two. The third plate 134 is connected to the second plate 132. The first battery array 106 is directly adjacent to the first plate 130 and exchanges heat with the first cooling circuit 128 through the first plate 130. The connections between the first plate 130, the second plate 132, and the third plate 134 can be achieved through welding methods such as but not limited to brazing. This structure not only saves internal space in the vertical direction, but also gives the mid-tray 104 better strength.

In several further embodiments of the present disclosure, insulation films may be arranged between the first battery cells 120, and the side facing the first plate 130 of the first battery cells 120 is not provided with an insulation film, such as but not limited to polypropylene film, polyurethane film, polyethylene terephthalate film, etc. There are several insulation separators 136 arranged between the first plate 130 and the first battery cells 120. The insulation separators 136 are used to separate the first plate 130 from the lower side of the first battery cells 120 by a certain distance, such as but not limited to a distance of about 0.3-2.0 millimeters. As shown in the figure, the insulation separators 136 can be several strip-shaped pieces extending along the first direction X, which can be connected to the mid-tray 104 and spaced parallel to each other. The material of the insulation separators 136 can be insulation materials such as polytetrafluoroethylene. It should be understood that these specific features can be adjusted adaptively according to different battery structures, and are not intended for limitation. This structure isolates the first battery cells 120 and the mid-tray 104 from each other, and at the same time, enhances the firmness of the bonding between the two. Furthermore, an insulating coating, such as PTFE coating, ceramic coating, etc., can be coated on the surface of the first plate 130 facing the first battery array 106. A thermal interface material, such as thermal conductive adhesive, thermal conductive structural adhesive, etc., is provided between the first battery cells 120 and the first plate 130 to provide better thermal conductivity and connection effects.

Referring back to FIG. 6, in some embodiments according to the present disclosure, the mid-tray 104 is connected to the first beam 164. As shown in the figure, the mid-tray 104 is arranged on the first beam 164 and connected to the first beam 164 through fasteners. This structure can assist in maintaining the relative position of the mid-tray 104 and provide certain support, improving structural stability.

Referring to FIGS. 7 and 9, in several embodiments of the present disclosure, the battery pack 100 further comprises several mid-tray brackets 118 extending along the first direction X, through which the mid-tray 104 is supported on the tray 102. The mid-tray brackets 118 are arranged along the first direction X to provide support for the mid-tray 104, thereby improving its structural stability. Technicians in this field can understand that the position of the mid-tray brackets 118 can also be adjusted according to structural needs, not limited to the edge positions shown in the figure.

Referring to FIG. 8 and also to FIG. 16, according to some embodiments of the present disclosure, the battery pack 100 further includes a third battery array 138 arranged in the mid-tray 104 and spaced apart from the first battery array 106. The first cooling circuit 128 includes a first sub circuit 140 and a second sub circuit 142. The first sub circuit 140 is used for thermal management of the first battery array 106, and the second sub circuit 142 is used for thermal management of the third battery array 138. The first sub circuit 140 and the second sub circuit 142 are connected in parallel, as shown in FIG. 16. That is to say, the coolant entering the first cooling circuit 128 will flow in parallel into the first sub circuit 140 and the second sub circuit 142, in order to provide heat dissipation for both the first battery array 106 and the third battery array 138, allowing each battery array to have sufficient opportunities for heat exchange during operation.

Referring to FIG. 14, in several embodiments of the present disclosure, the mid-tray 104 comprises a mid-tray flange 160 extending upwards around its periphery. That is to say, the peripheral part of the mid-tray 104 is bent upwards to form a roughly shallow disc-shaped structure. For example, the mid-tray flange 160 can be formed by the first plate 130, and of course, the mid-tray flange 160 can also be formed by the second plate 132 and the third plate 134. For example, during the process of applying thermal conductive structural adhesive between the battery arrays and the mid-tray 104, this structure can help limit material overflow to some extent and facilitate processing convenience.

Next, referring to FIG. 18, several other embodiments of the present disclosure are shown, wherein the battery pack 100′ includes a tray 102′, a mid-tray 104′, a first battery array 106′, a second battery array 108′, a first beam 164′, first endplates 122′, and second endplates 126′. The first battery array 106′ is arranged in the mid-tray 104′, and the second battery array 108′ is arranged in the tray 102′. The first beam 164′ is arranged in the tray 102′ and extends along the first direction X. In this embodiment, the array brackets form a part of the first endplates 122′ and/or the second endplates 126′. That is to say, the array brackets are integrated with the first endplates 122′ and/or the second endplates 126′. In this way, the first endplates 122′ and the second endplates 126′ support each other, and the part where the first endplates 122′ and the second endplates 126′ are in contact can be regarded as the corresponding array brackets. The extension direction Y of the first endplates 122′ and/or the second endplates 126′ can be understood as the extension direction of the array brackets. This structure can reduce the overall number of components and simplify assembly. In addition, in other embodiments, several array brackets can also be integrated into an integrated longitudinal component. That is to say, multiple array brackets are connected together, extending along the second direction Y, which can also reduce the number of components.

Technicians in this field can understand that the manufacturing materials for various components of battery pack 100, including the tray 102, the mid-tray 104, the first battery array 106, the second battery array 108, the first beam 164, the first endplates 122, the second endplates 126, and the array brackets 112, as described above and below, may include but are not limited to various types of aluminum alloys, magnesium alloys, various low, medium, and high carbon steels, and any other metal/non-metal or synthetic/composite materials; furthermore, the processing and manufacturing of the various components of the battery pack 100 mentioned above can be achieved through methods such as but not limited to extrusion, stamping, casting, molding, 3D printing, etc. In addition, the joints or connections mentioned above or below can be achieved through various alternative methods, such as welding, bonding, clamping, riveting, threaded connection, integrated forming, etc. The welding may include, but is not limited to, inert gas shielded welding, laser welding, etc.

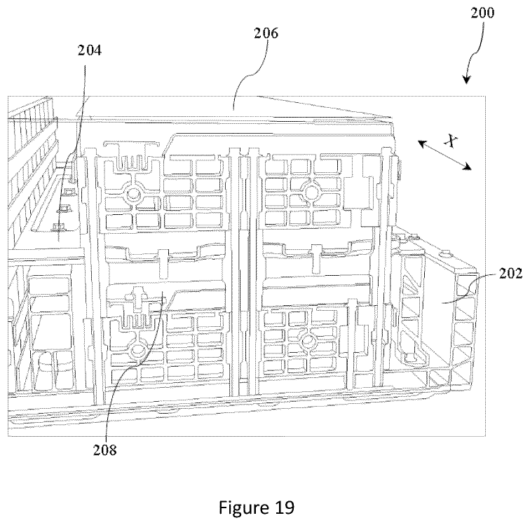

In addition, according to another aspect of the present disclosure, a battery pack 200 is provided. As shown in FIG. 19, the battery pack 200 comprises a tray 202, a mid-tray 204, a first battery array 206, and a second battery array 208. The first battery array 206 is arranged in the mid-tray 204 and extends along the first direction X. The second battery array 208 is arranged in the tray 202. Wherein, opposite ends of the first battery array 206 in the first direction X are connected to the tray 202. It should be understood that all embodiments, features, and advantages described above for the battery pack 100 according to the first aspect of the present disclosure are equally applicable to the battery pack 200 according to the other aspect of the present disclosure, provided that they do not conflict with each other. That is to say, all embodiments and their variations described above can be directly applied and combined with them. For the sake of brevity in this disclosure, it will not be repeated here.

Furthermore, according to yet another aspect of the present disclosure, a vehicle 10 is provided, referring to FIG. 1, comprising the battery packs 100 and 200 as described in any of the above embodiments. Similarly, it should be understood that all embodiments, features, and advantages described above for battery packs 100 and 200 according to the present disclosure are equally applicable to vehicle 10 according to another aspect of the present disclosure, provided that they do not conflict with each other. That is to say, all embodiments and their variations described above can be directly applied and combined with them. For the sake of brevity in this disclosure, it will not be repeated here.

It should be understood that, on the premise of technical feasibility, the technical features listed above for different embodiments can be combined with each other to form other embodiments within the scope of the present disclosure.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack, comprising:
a tray;
a mid-tray;
a first battery array arranged in the mid-tray;
a second battery array arranged in the tray;
a first beam extending in a first direction and arranged in the tray; and
array brackets extending in a second direction different from the first direction, wherein opposite ends of the first battery array in the first direction are connected to the tray through the array brackets.

2. The battery pack according to claim 1, wherein the array brackets are supported at ends of the second battery array in the first direction and supported on the tray through the second battery array.

3. The battery pack according to claim 1, wherein an angle between 80 and 100 degrees is formed between the first direction and the second direction.

4. The battery pack according to claim 1, wherein the mid-tray is supported on and fixed to the array brackets.

5. The battery pack according to claim 4, wherein the mid-tray comprises tray lugs at its edges, the array brackets each comprising longitudinally extended support legs and a transverse arm portion connected to the longitudinally extended support legs, wherein the tray lugs are supported on and fixed to the transverse arm portions of the array brackets.

6. The battery pack according to claim 5, wherein the array brackets each comprise at least an H-shaped structure.

7. The battery pack according to claim 1, further comprising mid-tray brackets extending along the first direction, through which the mid-tray is supported on the tray.

8. The battery pack according to claim 1, wherein the first battery array comprises several first battery cells arranged side by side along the first direction and first endplates that compresses the first battery cells in the first direction from both sides, the second battery array comprises several second battery cells arranged side by side along the first direction and second endplates that compresses the second battery cells in the first direction from both sides, the array brackets are connected to the first endplates and the second endplates, and the second endplates are supported on the tray.

9. The battery pack according to claim 8, wherein the array brackets each form a part of the first endplates, the second endplates, or both the first endplates and the second endplates.

10. The battery pack according to claim 1, wherein the mid-tray comprises a first cooling circuit for thermal management of the first battery array.

11. The battery pack according to claim 10, wherein the mid-tray comprises a first plate, a second plate, and a third plate, the first plate is connected to the second plate and the first cooling circuit is formed between the two, the first plate is in contact with the first battery array, and the third plate is connected to the second plate.

12. The battery pack according to claim 11, wherein the first battery array comprises several first battery cells arranged side by side along the first direction, insulation films are arranged between the first battery cells and insulation film is not included on the side facing the first plate, and several insulation separators are arranged between the first plate and the first battery cells to separate the first plate from the side facing the first plate of the first battery cells.

13. The battery pack according to claim 10, further comprising a third battery array arranged in the mid-tray and spaced apart from the first battery array, the first cooling circuit comprises a first sub circuit for thermal management of the first battery array and a second sub circuit for thermal management of the third battery array, and the first sub circuit and the second sub circuit are connected in parallel.

14. The battery pack according to claim 1, wherein the mid-tray comprises a mid-tray flange extending upwards around its periphery.

15. The battery pack according to claim 8, wherein the first endplate comprises a first portion that protrudes from a vertical middle position at an installation position and a second portion that extends from the first portion to upper and lower sides, and the second endplate comprises a third portion that protrudes from a vertical middle direction at the installation position and a fourth portion that extends from the third portion to upper and lower sides.

16. The battery pack according to claim 15, further comprising support connectors, the first portion, the third portion, and the array bracket each contain a plurality of through holes that extend vertically, the support connectors sequentially pass through at least one through hole in the first portion, the array bracket, and the third portion and are further fixed to the tray.

17. The battery pack according to claim 16, wherein the tray comprises a tray frame extending along the second direction, and the support connectors are fixed to the tray frame.

18. The battery pack according to claim 1, wherein the mid-tray is connected to the first beam.

19. A battery pack, comprising:
a tray;
a mid-tray;
a first battery array arranged in the mid-tray and extending in a first direction; and
a second battery array arranged in the tray;
wherein opposite ends of the first battery array in the first direction are connected to the tray.

20. A vehicle comprising the battery pack of claim 1.
